(19) United States
(12) Patent Application Publication
(10) Pub. No.: US 2015/0012432 A1
(43) Pub. Date: Jan. 8, 2015

(54) SYSTEMS AND METHODS FOR MANAGING PERSONAL RECORDS ASSOCIATED WITH PAYMENT TRANSACTIONS

(71) Applicant: MasterCard International Incorporated, Purchase, NY (US)

(72) Inventor: Trevor Scott Owen, O'Fallon, MO (US)

(21) Appl. No.: 13/936,981

(22) Filed: Jul. 8, 2013

(51) Int. Cl. G06Q 20/40

(52) U.S. Cl. CPC G06Q 20/40
USPC 705/44

(57) ABSTRACT

A method for processing a payment transaction and a personal record associated with the payment transaction is provided. The method includes receiving a request to authorize the payment transaction wherein the authorization request includes a cardholder ID and a payment transaction amount, and transmitting an authorization confirmation message to at least one of a cardholder computing device and a first service provider computing device. The method also includes receiving a request to process a personal record transaction associated with the payment transaction and a second service provider, and processing the personal record transaction including at least one of (i) storing the personal record in the memory, and (ii) transmitting the personal record to at least one of the cardholder and the second service provider. The second service provider may be the same as or different than the first service provider.

### BACKGROUND OF THE DISCLOSURE

The field of the disclosure relates generally to a payment and record management computer system, and more particularly to a network-based method and system for managing personal records associated with payment transactions.

Personal records, such as passports, medical records, legal documents, financial statements, etc. are commonly used in various aspects of daily life in order to provide identification, provide a financial or medical history, and document a person's legal decisions. However, these records may be too voluminous to carry or are not readily available to a person for fear of being lost, damaged, or stolen.

In some instances, the ability of a user to store information is insufficient. For example, a service provider may require a copy of a user's information, or may require more than a simple visual inspection to verify the record. In these cases, the user needs to be able to provide a copy of the personal record to a service provider. In addition the personal records oftentimes need to be stored in a secured location.

Such personal records may also require updating by the user. Personal records are frequently connected with a payment transaction. A personal record may be used by a service provider to show the identity and credit worthiness of a buyer prior to the completion of a sale. For example, a car dealership may request a driver's license and proof of insurance during the process of selling a new car. A personal record may need to be updated with new information after a purchase is completed. For example, tax records, home insurance records, and home inventory lists may all need to be modified after a large purchase is completed.

Systems for storing personal records electronically and physically are known. However, such systems often require the user to manually update the personal records. Further such systems are not capable of processing payment transactions or associating a personal record with a payment transaction.

### BRIEF DESCRIPTION OF THE DISCLOSURE

In one aspect, a computer-implemented method for processing a payment transaction and a personal record associated with the payment transaction initiated by a cardholder is provided. Said method is implemented by a host computing device communicatively coupled to a memory, and includes receiving, at the host computing device, a request to authorize the payment transaction, wherein the authorization request includes a cardholder ID and a payment transaction amount. Said method also includes transmitting an authorization confirmation message to at least one of a cardholder computing device and a first service provider computing device, the first service provider computing device being associated with a first service provider, the first service provider being associated with the payment transaction. Said method also includes receiving a request to process a personal record transaction associated with the payment transaction and a second service provider, the second service provider having a second service provider computing device. Said method also includes processing, by the host computing device, the personal record transaction including at least one of (i) storing the personal record in the memory, and (ii) transmitting the personal record from the host computing device to at least one of the cardholder computing device and the second service provider computing device, wherein the second service provider is the same as the first service provider or different than the first service provider.

In another aspect, a payment and record management computer system for processing a payment transaction and a personal record associated with the payment transaction, the payment transaction initiated by a cardholder. The computer system comprises a memory and a host computing device communicatively coupled to the memory. The host computing device configured to receive, at the host computing device, a request to authorize the payment transaction, wherein the authorization request includes a cardholder ID and a payment transaction amount. The host computing device further configured to transmit an authorization confirmation message to at least one of a cardholder computing device and a first service provider computing device, the first service provider computing device being associated with a first service provider, the first service provider being associated with the payment transaction. The host computing device further configured to receive a request to process a personal record transaction associated with the payment transaction and a second service provider, the second service provider having a second service provider computing device. The host computing device further configured to process the personal record transaction including at least one of (i) storing the personal record in the memory, and (ii) transmitting the personal record to at least one of the cardholder computing device and the second service provider computing device, wherein the second service provider is the same as the first service provider or different than the first service provider.

In another aspect, a computer readable medium having computer-executable instructions embodied thereon is provided. When executed by a host computing device having at least one processor, the computer-executable instructions cause the at least one processor to receive a request to authorize a payment transaction initiated by a cardholder, wherein the authorization request includes a cardholder ID and a payment transaction amount, and transmit an authorization confirmation message to at least one of a cardholder computing device and a first service provider computing device, the first service provider computing device being associated with a first service provider, the first service provider being associated with the payment transaction. The instructions also cause the processor to receive a request to process a personal record transaction associated with the payment transaction and a second service provider, the second service provider having a second service provider computing device. The instructions also cause the at least one processor to process the personal record transaction including at least one of (i) storing the personal record in the memory, and (ii) transmitting the personal record to at least one of the cardholder computing device and the second service provider computing device, wherein the second service provider is the same as the first service provider or different than the first service provider.

### BRIEF DESCRIPTION OF THE DRAWINGS

FIG. 1 shows a system of interrelated steps describing a conventional payment card initiated payment transaction.

FIG. 2 is a simplified block diagram of an example payment and record management computer system for processing payment transactions initiated by a cardholder and managing personal records associated with the payment transaction in accordance with the present disclosure.

FIG. 3 illustrates an example configuration of one of a service provider computing device, and cardholder computing device as shown in FIG. 2.

FIG. 4 illustrates an example configuration of a host computing device as shown in FIG. 2.

FIG. 5 illustrates a simplified block diagram of an example process implemented by the payment and record management computer system shown in FIG. 2.

FIG. 6 is a component view of the payment and record management computer system as illustrated in FIG. 2.

### DETAILED DESCRIPTION OF THE DISCLOSURE

Described in detail herein are example embodiments of systems and methods for processing payment transactions initiated by a cardholder and managing personal records associated with the payment transaction.

More specifically, in the example embodiment, a payment and personal record management computer system is described that includes a host computing device in communication with a payment network, a cardholder computing device, at least one service provider computing device, and a memory. In at least one embodiment, the host computing device is a server or system of servers for performing the functions described herein. In other embodiments, the host computing device may be any other kind of computing device capable of performing the functions described herein.

In the example embodiment, the host computing device is configured to receive cardholder data that includes at least a cardholder identifier, (cardholder ID). In the example embodiment, the cardholder ID may be any information sufficient to identify the cardholder, including a cardholder name and/or a cardholder account number. In some embodiments, cardholder data may further include additional information for verifying the cardholder ID, including but not limited to, a pin code, a password, a biometric identifier, or any other input capable of confirming the identity of the cardholder.

The host computing device is configured to store the cardholder data in the memory. The memory may also contain service provider data including a list of valid service provider identifiers (service provider IDs), that identify each service provider registered to use the system.

The host computing device is further configured to receive a request to authorize a new payment transaction wherein the authorization request includes payment transaction data. The payment transaction data includes at least a cardholder ID associated with the payment transaction and a payment transaction amount. The payment transaction data may also include a service provider ID indicating the identity of a service provider that is associated with the payment transaction. The host computing device may be configured to associate the cardholder ID associated with the payment transaction with a cardholder ID stored in memory.

The host computing device is further configured to transmit the request to authorize a new payment transaction to a payment network, and to receive a response from the payment network indicating whether the new payment transaction has been authorized. The host computing device may then transmit an authorization confirmation message to at least one of the cardholder computing device and a first service provider computing device associated with the payment transaction. The authorization confirmation message indicates whether the payment transaction has been authorized to proceed or has been declined.

The host computing device is further configured to receive a request to process a personal record transaction associated with the payment transaction, and to process the personal record transaction. Processing a personal record transaction may include at least one of processing a personal record storage transaction and a personal record transfer transaction.

Processing a personal record storage transaction may include receiving a personal record from at least one of the cardholder computing device and a second service provider computing device associated with the personal record, associating the personal record with a cardholder ID, and storing the personal record in the memory. The host computing device may be configured to store an entirely new personal record or update a pre-existing personal record. For example, a cardholder may request that tax records be updated after a purchase, and the host computing device may process the request and store the updated information in the memory.

Processing a personal record transfer transaction may include retrieving a previously stored personal record from the memory based at least in part on the cardholder ID, and transmitting it to at least one of the cardholder computing device and a second service provider computing device associated with the personal record. The personal record may be transmitted to the cardholder computing device to allow for personal use and viewing. Additionally, the personal record may be transmitted to the cardholder computing device so that a cardholder may display the personal record to the second service provider, without providing a copy to the second service provider. Alternatively, the personal record may be transmitted directly to the second service provider computing device. This allows a second service provider to have access to a permanent copy of the record, as well as improves security in the instance of a stolen and/or insecure cardholder computing device.

In some embodiments, the first service provider computing device associated with the payment transaction may be the same device as the second service provider computing device associated with the personal record. For example, the first service provider computing device associated with the payment transaction may be a merchant computing device from which the cardholder is purchasing an item, and the second service provider computing device associated with the personal record may be the same merchant computing device receiving identifying records or information. In some other embodiments, the first service provider computing device associated with the payment transaction may be different from the second service provider computing device associated with a personal record. For example, a payment transaction may be associated with a first service provider computing device, such as the computing device of a car dealership used in the purchasing of a car, and a second service provider computing device may be associated with the personal record, such as the computing device of the car insurance company that is covering the newly purchased car.

Also, in the example embodiment, the host computing device may be configured to transmit an associated personal record transaction request to the cardholder computing device regarding a payment transaction or a personal record transaction. The associated personal record transaction request may inform the cardholder that a personal record associated with a completed payment transaction or a completed personal record transaction is available to be processed. For example, the payment network may transmit associated personal record transaction request prompting the cardholder to take a picture of a recent purchase and store the photograph in their personal records. The associated personal record transaction request may also inform the cardholder that a personal record associated with a prior personal record transaction is available to be processed. For example, the payment network may transmit an associated personal record transaction request prompting the cardholder to transmit a picture stored in their personal records to an insurance company in order to update the cardholder's insurance records.

Also, in the example embodiment, the host computing device may be configured to transmit a transaction reward message to the cardholder computing device regarding a payment transaction. The transaction reward message may inform a cardholder of additional information associated with the payment transaction, such as discounts, available coupons, rewards points available, product reviews, and other similar information. For example, the host computing device may transmit a transaction reward message to a cardholder shopping at a department store, informing the cardholder that a discount is available for the current purchase if more money is spent. In another example, the payment network may transmit a transaction reward message to a cardholder shopping at a department store to inform the cardholder that a rebate or coupon is available for the current purchase.

The personal record may, but need not be, associated with a specific payment transaction at the time it is stored. For example, a cardholder may store an identification card, such as a driver's license, in anticipation of future purchases in which identification will be required, but without a particular purchase in mind.

Further in the example embodiment, the cardholder computing device may be configured to verify the identity of the cardholder prior to transferring funds or personal records to the first service provider and the second service provider respectively. The cardholder's identity may be verified by requiring a cardholder to input a pin code, a password, a biometric identifier, or some other input capable of confirming the identity of the cardholder, and comparing the information with data stored in the memory.

The host computing device may be further configured to verify the identity of the first service provider prior to transferring funds, and to verify the identity of the second service provider prior to transmitting personal records. The first and second service provider computing devices may transmit a service provider ID, such as an authentication key or other identifying information, to the host computing device, and the host computing device may analyze the service provider ID to determine whether the first and second service providers are authorized to receive funds or personal records.

The cardholder computing device may be configured to display a list of payment accounts available to the cardholder for transferring funds, as well as determine the payment account indicated by the cardholder. The host computing device may be further configured to request authorization for a transfer of funds to the first service provider payment account from the cardholder payment account as indicated by the cardholder computing device. Examples of payment accounts include, but are not limited to, savings accounts, checking accounts, payment card accounts, pre-paid accounts, and any other account capable of transferring a payment.

The cardholder computing device may be configured to display a list of personal records available to be stored by the host computing device, and to determine the personal record selected by a user for storage. The cardholder computing device may also be configured to display a list of personal records available to be transmitted by the host computing device to a recipient.

As used herein, the term “payment transaction,” “financial transaction” or “transaction” refers to any suitable payment transaction, such as a credit card transaction, debit card transaction, gift card transaction, charge card transaction, bank transfer, or any other transaction in which some value or credit is transferred from an account associated with a cardholder to an account associated with the first service provider.

In at least one embodiment, the payment transaction may be a card-not-present payment card transaction. As used herein, the term “card-not-present transaction” refers to a transaction in which a cardholder's payment card is not necessarily present at the time the transaction is initiated, but instead, the cardholder's account is identified without use of the physical payment card. For example, a consumer/cardholder purchasing a product or service via a cardholder computing device. The merchant then initiates a transaction for the product or service using the account information entered by the consumer, without the payment card in the presence of the merchant.

As used herein, the term “service provider” refers to any establishment that may be related to a personal record, including but not limited to a merchant, a medical services provider, a legal services provider, a bank, or any other third-party.

As used herein, the term “personal record” refers to any record containing information related to the cardholder's financial, legal, medical, insurance, tax, entertainment, educational, or personal affairs. Such records include without limitation, passports, driver's licenses, medical records, insurance records, tax records, bank records, photographs, inventory lists, receipts, and other similar records.

As used herein, the term “payment card” refers to any suitable transaction card, such as a credit card, a debit card, a pre-paid card, a charge card, a gift card, or any other card that can be used as a method of payment for performing a payment transaction.

The “cardholder computing device” refers to a computer device and/or mobile device used by a cardholder for making a purchase, transmitting a personal record, storing a personal record, and/or displaying a personal record. Cardholder computing device may be without limitation a computer, smartphone, PDA, tablet, or any other device capable of performing the functions described herein. The cardholder computing device may store payment card information and utilize the stored payment card information to perform payment transactions.

A “service provider computing device” refers to a computer device and/or mobile device used by a service provider for receiving personal records and/or for processing payment transactions. Service provider computing device may be without limitation a computer, smartphone, PDA, tablet, or any other device capable of performing the functions described herein.

The methods and systems described herein may be implemented using computer programming or engineering techniques including computer software, firmware, hardware, or any combination or subset thereof, wherein the technical effects may include at least one of: (a) receiving, at the host computing device, a request to authorize the payment transaction, wherein the authorization request includes a cardholder ID and a payment transaction amount; (b) transmitting an authorization confirmation message to at least one of a cardholder computing device and a first service provider computing device, the first service provider computing device being associated with a first service provider, the first service provider being associated with the payment transaction; (c) receiving a request to process a personal record transaction associated with the payment transaction and a second service provider, the second service provider having a second service provider computing device; and (d) processing, by the host computing device, the personal record transaction including at least one of storing the personal record in the memory, and transmitting the personal record from the host computing device to at least one of the cardholder computing device and the second service provider computing device,

The following detailed description illustrates embodiments of the disclosure by way of example and not by way of limitation. It is contemplated that the embodiments have general application to processing financial transaction data and personal records. However, this disclosure is not intended to be limited to the embodiments described herein, but could be used in various other embodiments that are also covered by this disclosure.

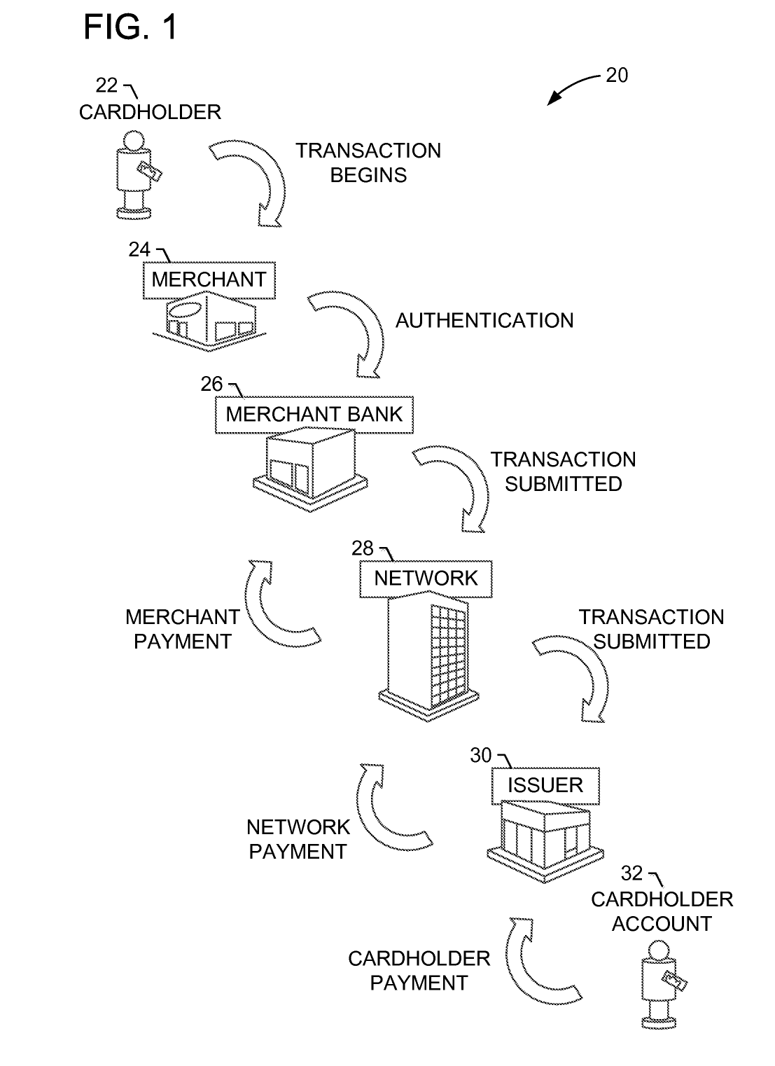

FIG. 1 is a schematic diagram illustrating an example multi-party transaction card industry system 20 for enabling ordinary payment-by-card transactions in which merchants 24 and card issuers 30 do not need to have a one-to-one special relationship. Embodiments described herein may relate to a transaction card system, such as a credit card payment system using the MasterCard® interchange network. The MasterCard® interchange network is a set of proprietary communications standards promulgated by MasterCard International Incorporated® for the exchange of financial transaction data and the settlement of funds between financial institutions that are members of MasterCard International Incorporated®. (MasterCard is a registered trademark of MasterCard International Incorporated located in Purchase, New York).

In a typical transaction card system, a financial institution called the “issuer” issues a transaction card, such as a credit card, to a consumer or cardholder 22, who uses the transaction card to tender payment for a purchase from a merchant 24. To accept payment with the transaction card, merchant 24 must normally establish an account with a financial institution that is part of the financial payment system. This financial institution is usually called the “merchant bank,” the “acquiring bank,” or the “acquirer.” When cardholder 22 tenders payment for a purchase with a transaction card, merchant 24 requests authorization from a merchant bank 26 for the amount of the purchase. The request may be performed over the telephone, but is usually performed through the use of a point-of-sale terminal, which reads cardholder's 22 account information from a magnetic stripe, a chip, or embossed characters on the transaction card and communicates electronically with the transaction processing computers of merchant bank 26. Alternatively, merchant bank 26 may authorize a third-party to perform transaction processing on its behalf. In this case, the point-of-sale terminal will be configured to communicate with the third-party. Such a third-party is usually called a “merchant processor,” an “acquiring processor,” or a “service provider processor.”

Using a payment network 28, computers of merchant bank 26 or merchant processor will communicate with computers of an issuer bank 30 to determine whether the payment transaction should be authorized. This may include a number of factors such as, whether cardholder's 22 account 32 is in good standing, and whether the purchase is covered by cardholder's 22 available credit line. If the request is accepted, an authorization code is issued to merchant 24.

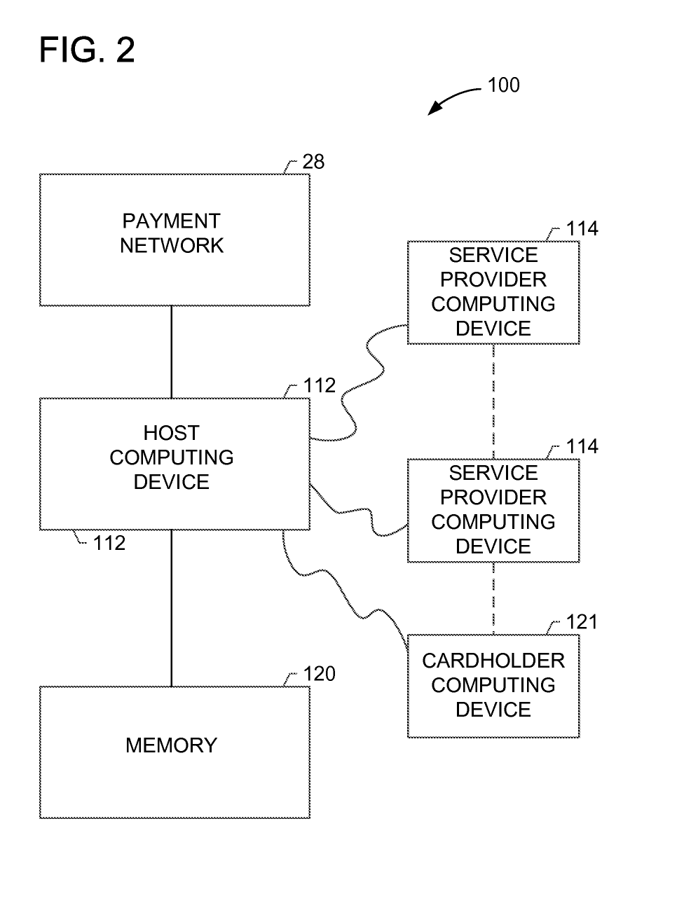

When a request for authorization is accepted, the available credit line of cardholder's 22 account 32 is decreased. Normally, a charge for a payment card transaction is not posted immediately to cardholder's 22 account 32 because bankcard associations, such as MasterCard International Incorporated®, have promulgated rules that do not allow merchant 24 to charge, or “capture,” a transaction until goods are shipped or services are delivered. However, with respect to at least some debit card transactions, a charge may be posted at the time of the transaction. When merchant 24 ships or delivers the goods or services, merchant 24 captures the transaction by, for example, appropriate data entry procedures on the point-of-sale terminal. This may include bundling of approved transactions daily for standard retail purchases. If cardholder 22 cancels a transaction before it is captured, a “void” is generated. If cardholder 22 returns goods after the transaction has been captured, a “credit” is generated. Payment network 28 and/or issuer bank 30 stores the transaction card information, such as a type of merchant, amount of purchase, date of purchase, in a memory 120 (shown in FIG. 2).

For debit card transactions, when a request for a PIN authorization is approved by the issuer, the consumer's account is decreased. Normally, a charge is posted immediately to a consumer's account. The bankcard association then transmits the approval to the acquiring processor for distribution of goods/services, or information or cash in the case of an ATM.

After a purchase has been made, a clearing process occurs to transfer additional transaction data related to the purchase among the parties to the transaction, such as merchant bank 26, payment network 28, and issuer bank 30. More specifically, during and/or after the clearing process, additional data, such as a time of purchase, a merchant name, a type of merchant, purchase information, cardholder account information, a type of transaction, itinerary information, information regarding the purchased item and/or service, and/or other suitable information, is associated with a transaction and transmitted between parties to the transaction as transaction data, and may be stored by any of the parties to the transaction. In the example embodiment, when cardholder 22 purchases travel, such as airfare, a hotel stay, and/or a rental car, at least partial itinerary information is transmitted during the clearance process as transaction data. When interchange network 28 receives the itinerary information, interchange network 28 routes the itinerary information to database 120.

After a transaction is authorized and cleared, the transaction is settled among merchant 24, merchant bank 26, and issuer bank 30. Settlement refers to the transfer of financial data or funds among merchant's 24 account, merchant bank 26, and issuer bank 30 related to the transaction. Usually, transactions are captured and accumulated into a “batch,” which is settled as a group. More specifically, a transaction is typically settled between issuer bank 30 and interchange network 28, and then between interchange network 28 and merchant bank 26, and then between merchant bank 26 and merchant 24.

FIG. 2 is a simplified block diagram of an example payment and personal record management system (referred to herein as a payment and record system) 100 including a plurality of computer devices, such as host computing device 112, service provider computing devices 114, and cardholder computing device 121.

More specifically, in the example embodiment, payment and record system 100 includes a host computing device 112, and a plurality of computing devices in communication with the host computing device 112 including, at least one service provider computing device 114, cardholder computing device 121, payment network 28 and memory 120. In one embodiment, the at least one service provider computing device 114 and cardholder computing device 121 are computers including a web browser, such that host computing device 112 is accessible using the Internet. The at least one service provider computing device 114 and cardholder computing device 121 are interconnected to the Internet through many interfaces including a network, such as a local area network (LAN) or a wide area network (WAN), dial-in-connections, cable modems, and special high-speed Integrated Services Digital Network (ISDN) lines. The at least one service provider computing device 114 and cardholder computing device 121 may be any device capable of interconnecting to the Internet including a web-based phone, PDA, or other web-based connectable equipment.

Memory 120 contains information on a variety of matters, as described below in greater detail. In one embodiment, centralized memory 120 is stored on host computing device 112 and can be accessed by potential users by logging onto host computing device 112. In an alternative embodiment, memory 120 is stored remotely from host computing device 112 and may be non-centralized.

Memory 120 may include a single database having separated sections or partitions or may include multiple databases, each being separate from each other. Memory 120 may store payment transaction data generated as part of sales activities conducted over the processing network including data relating to merchants, account holders or customers, issuers, acquirers, and/or purchases made. Memory 120 may also store account data including at least one of a cardholder name, a cardholder address, an account number, and other account identifier. Memory 120 may also store a list of service provider IDs, the list including each service provider registered to use the system. Memory 120 may also store purchase data associated with items being purchased by a cardholder from a service provider, such as merchant 24, and authorization request data.

In the example embodiment, at least one service provider computing device 114 may be associated with acquirer bank 26 (shown in FIG. 1) or with issuer bank 30 (shown in FIG. 1). Host computing device 112 may be associated with payment network 28. Host computing device 112 may be used for processing payment transaction data.

Payment and record system 100 includes at least one service provider computing device 114. In some embodiments, service provider computing device 114 may be a computer and/or mobile device used by a service provider to facilitate payment transactions or receive personal records, such as a computer, smartphone, PDA, tablet, or any other device capable of performing the functions described herein. In the example embodiment, the at least one service provider computing device 114 includes a memory and a computing device in communication with the memory, and may be communicatively coupled to cardholder computing device 121 and host computing device 112. In some embodiments, a plurality of service provider computing devices 114 are included in system 100. For example, a first service provider computing device 114 may be associated with the payment transaction, and a second service provider computing device 114 may be associated with the personal record transaction.

Payment and record system 100 includes a cardholder computing device 121. Cardholder computing device 121 may be a computer device and/or mobile device used by a cardholder making an on-line purchase or payment, such as a computer, smartphone, PDA, tablet, or any other device capable of performing the functions described herein. In the example embodiment, cardholder computing device 121 includes a memory and a computing device in communication with the memory and may be communicatively coupled to service provider computing device 114 and host computing device 112.

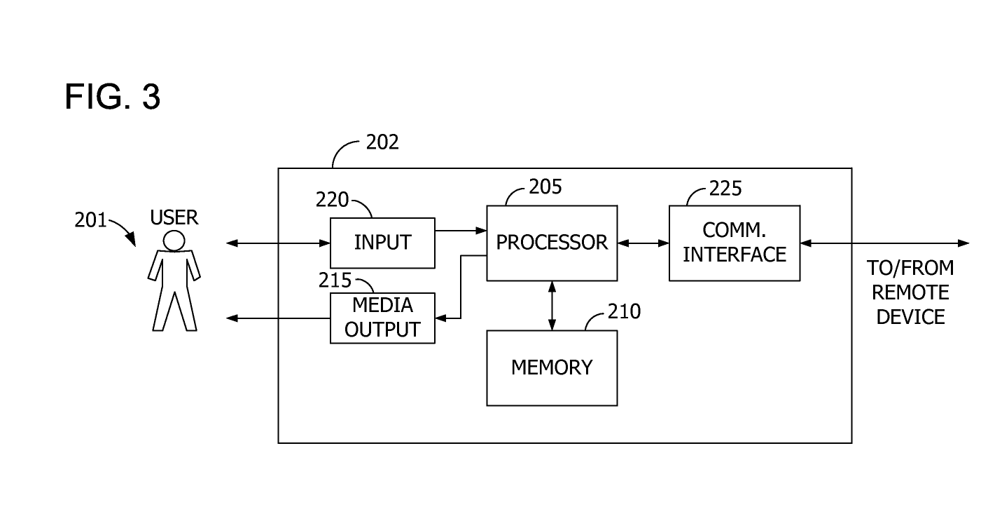

FIG. 3 illustrates an example configuration of a user system 202 operated by a user 201, such as cardholder 22 (shown in FIG. 1). User system 202 may include, but is not limited to, cardholder computing device 121 and service provider computing device 114. In the example embodiment, user system 202 includes a processor 205 for executing instructions. In some embodiments, executable instructions are stored in a memory area 210. Processor 205 may include one or more processing units, for example, a multi-core configuration. Memory area 210 is any device allowing information such as executable instructions and/or written works to be stored and retrieved. Memory area 210 may include one or more computer readable media.

User system 202 also includes at least one media output component 215 for presenting information to user 201. Media output component 215 is any component capable of conveying information to user 201. In some embodiments, media output component 215 includes an output adapter such as a video adapter and/or an audio adapter. An output adapter is operatively coupled to processor 205 and operatively couplable to an output device such as a display device, a liquid crystal display (LCD), organic light emitting diode (OLED) display, or “electronic ink” display, or an audio output device, a speaker or headphones.

In some embodiments, user system 202 includes an input device 220 for receiving input from user 201. Input device 220 may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of media output component 215 and input device 220. User system 202 may also include a communication interface 225, which is communicatively couplable to a remote device such as host computing device 112. Communication interface 225 may include, for example, a wired or wireless network adapter or a wireless data transceiver for use with a mobile phone network, Global System for Mobile communications (GSM), 3G, or other mobile data network such as WIMAX.

Stored in memory area 210 are, for example, computer readable instructions for providing a user interface to user 201 via media output component 215 and, optionally, receiving and processing input from input device 220. A user interface may include, among other possibilities, a web browser and client application. Web browsers enable users, such as user 201, to display and interact with media and other information typically embedded on a web page or a website from host computing device 112. A client application allows user 201 to interact with a server application from host computing device 112.

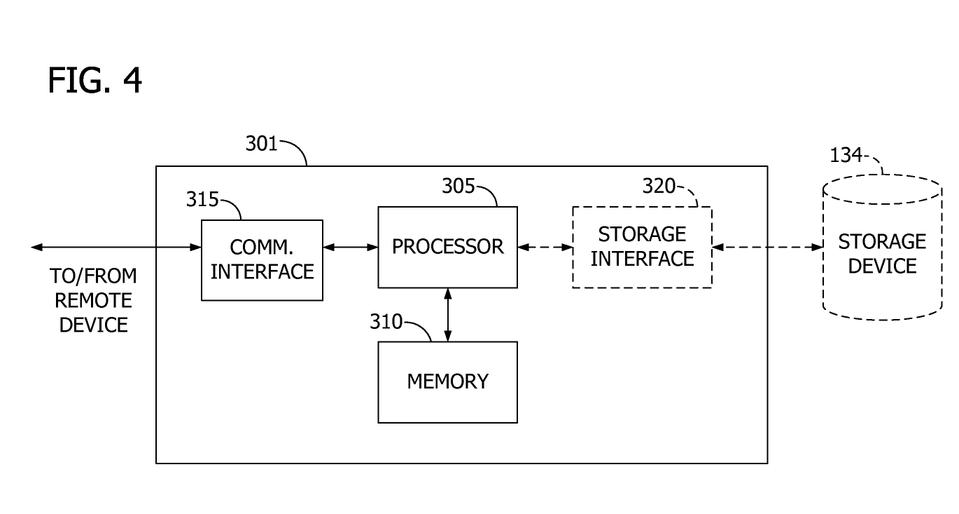

FIG. 4 illustrates an example configuration of a server system 301 such as host computing device 112 (shown in FIG. 2).

Server system 301 includes a processor 305 for executing instructions. Instructions may be stored in a memory area 310, for example. Processor 305 may include one or more processing units (e.g., in a multi-core configuration) for executing instructions. The instructions may be executed within a variety of different operating systems on the server system 301, such as UNIX® (UNIX is a registered trademark of X/Open Company Limited located in Reading, Berkshire, United Kingdom), Microsoft Windows® (Windows is a registered trademark of Microsoft Corporation, Redmond, Wash.), etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 305 is operatively coupled to a communication interface 315 such that server system 301 is capable of communicating with a remote device such as a user system or another server system 301. For example, communication interface 315 may receive requests from client system 114 and cardholder computing device 121 via the Internet, as illustrated in FIGS. 2 and 3.

Processor 305 may be operatively coupled to a storage device 134. Storage device 134 is any computer-operated hardware suitable for storing and/or retrieving data. In some embodiments, storage device 134 is integrated in server system 301. For example, server system 301 may include one or more hard disk drives as storage device 134. In other embodiments, storage device 134 is external to server system 301 and may be accessed by a plurality of server systems 301. For example, storage device 134 may include multiple storage units such as hard disks or solid state disks in a redundant array of inexpensive disks (RAID) configuration. Storage device 134 may include a storage area network (SAN) and/or a network attached storage (NAS) system.

In some embodiments, processor 305 is operatively coupled to storage device 134 via a storage interface 320. Storage interface 320 is any component capable of providing processor 305 with access to storage device 134. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 134.

Memory area 310 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are example only, and are thus not limiting as to the types of memory usable for storage of a computer program.

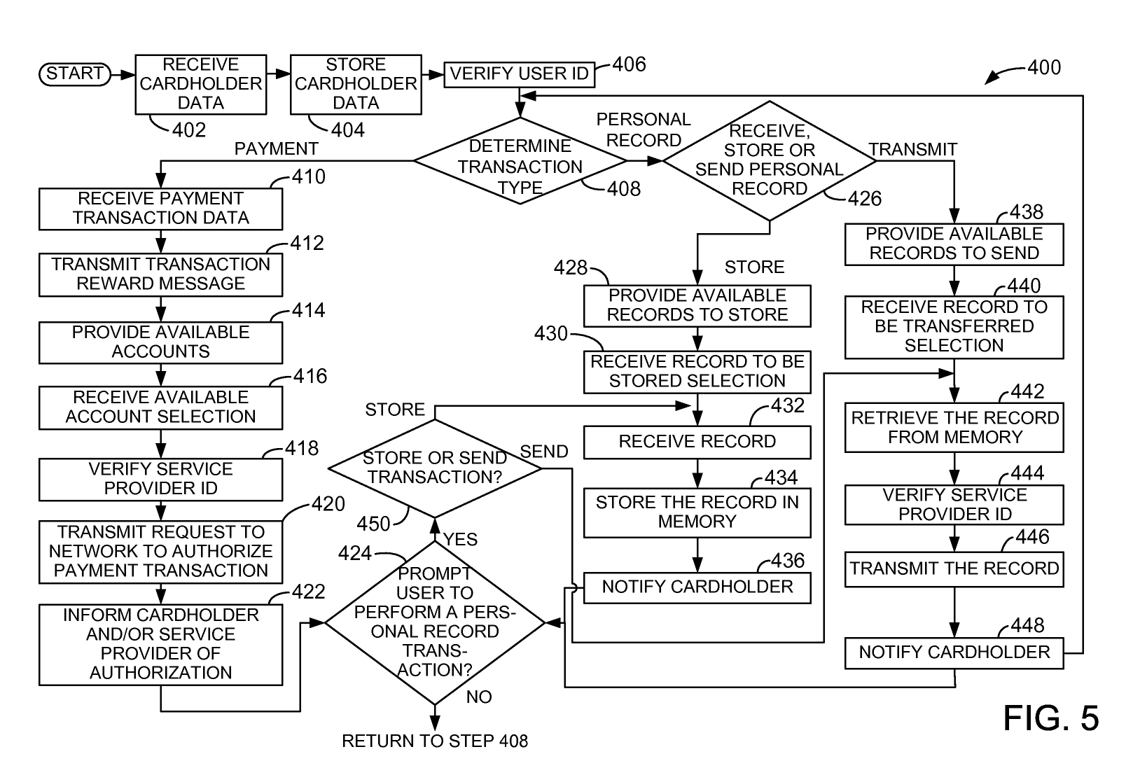

FIG. 5 illustrates a simplified block diagram of an example process 400 implemented by the payment and record system 100 shown in FIG. 2.

In the example embodiment, host computing device 112 (shown in FIG. 2) is configured to receive, at Block 402, cardholder data associated with cardholder 22, (shown in FIG. 1) wherein the cardholder data includes at least a cardholder identifier, referred to as a cardholder ID. The cardholder ID indicates at least the identity of cardholder 22, and in the example embodiment may be at least one of a cardholder name and a cardholder account number. The cardholder data may also include at least one of a pin code, a password, a biometric identifier, or other input capable of verifying the identity of cardholder 22. If the cardholder data is new to the system, host computing device 112 is configured to store, at Block 404, the cardholder data in memory 120. If cardholder 22 has previously stored cardholder data, host computing device 112 is configured to associate the cardholder 22 with the stored cardholder data.

In the example embodiment, host computing device 112 is configured to verify, at Block 406, the identity of cardholder 22. In the example embodiment, host computing device 112 may be configured to verify the identity of the cardholder by comparing the at least one of a pin code, a password, a biometric identifier, or other input capable of verifying the identity stored in memory 120 with a received input. In the example embodiment, the cardholder is verified before processing a payment transaction or processing a personal record transaction.

Also, in the example embodiment, host computing device 112 may be configured to determine, at Block 408, based on a signal received from cardholder computing device 121, whether a personal record transaction or payment transaction is desired. A personal record transaction refers to any transaction in which a personal record is either stored in memory 120 or transmitted from the host computing device 112 to at least one of a cardholder computing device 121 and a service provider computing device 114 associated with the personal record. A payment transaction refers to any transaction in which cardholder 22 requests a payment be made to a service provider. In at least one embodiment, the service provider is a merchant 24.

In the example embodiment, when a payment transaction is determined, host computing device 112 is configured to receive, at Block 410, payment transaction data from at least one of a service provider computing device 114 associated with the payment transaction and cardholder computing device 121. The payment transaction data includes at least one of a cardholder ID, a service provider identifier, referred to as a service provider ID, and a payment transaction amount. In the example embodiment, cardholder computing device 121 provides the cardholder ID, and the service provider computing device associated with the payment transaction provides the service provider ID and the payment transaction amount.

At Block 412, the host computing device 112 may be configured to transmit a transaction reward message to cardholder computing device 121 any time after receiving the payment transaction data. The transaction reward message may inform a cardholder 22 (shown in FIG. 1) of additional information associated with the payment transaction, such as discounts, available coupons, rewards points available, product reviews, and other similar information. For example, the transaction reward message may inform cardholder 22 that the store offers a 10% discount on diamond rings over $1,000.00. After accepting or declining the transaction reward message, cardholder 22 may return to the payment transaction.

In the example embodiment, the host computing device 112 may be configured to provide, at Block 414, available payment accounts from which cardholder 22 may make a payment. Examples of payment accounts include, but are not limited to, savings accounts, checking accounts, payment card accounts, pre-paid accounts, and any other account capable of transferring a payment.

Also, in the example embodiment, host computing device 112 may be configured to receive, at Block 416, a signal indicating the payment account cardholder 22 has selected to use for the payment transaction.

In at least some embodiments, host computing device 112 is further configured to verify, at Block 418, the service provider ID associated with the payment transaction. Host computing device 112 may be configured to compare the service provider ID associated with the payment transaction with a list of valid service provider IDs stored in memory before transmitting an authorization confirmation message to at least one of cardholder computing device 121 and service provider computing device 114.

Also in the example embodiment, host computing device 112 may be configured to transmit, at Block 420, an authorization request to payment network 28 to authorize the payment transaction. The authorization process is detailed and described above with respect to FIG. 1.

Further in the example embodiment, the host computing device 112 is configured to transmit, at Block 422, an authorization confirmation message to at least one of the service provider computing device 114 associated with the payment transaction and cardholder computing device 121.

Also, in the example embodiment, host computing device 112 may be configured prompt cardholder 22 with an associated personal record transaction request at Block 424. The associated personal record transaction request indicates that a personal record transaction associated with a completed payment transaction or with a completed personal record transaction is available to be performed. For example, if the payment transaction was to purchase a new vehicle, host computing device 112 may be configured to determine that an update to car insurance personal records is associated with the payment transaction. Host computing device 112 may then prompt cardholder 22 with an associated personal record transaction request indicating that an update to car insurance records is available.

Further in the example embodiment, if cardholder 22 accepts the prompt, host computing device 112 may be configured to determine, at Block 450, whether the associated personal record transaction is a personal record storage transaction or a personal record transfer transaction.

In the example embodiment, when a personal record transaction is determined at Block 408, host computing device 112 may further be configured to receive, at Block 426, an indication from cardholder computing device 121 of whether the personal record transaction is a personal record storage transaction or a personal record transfer transaction.

When the personal record transaction is determined to be a personal record storage transaction, host computing device 112 may be configured to cause cardholder computing device 121 to display, at Block 428, a list of personal records available to be stored to cardholder computing device 121. The records available to be stored may be located on cardholder computing device 121 and/or on service provider computing device 114. In the example embodiment, service provider computing device 114 may provide a list of personal records generated based on the payment transaction to host computing device 112. Host computing device 112 may further be configured to receive, at Block 430, an indication of the personal record cardholder 22 has selected to store.

In the example embodiment, host computing device 112 may receive the personal record to be stored at Block 432 from at least one of cardholder computing device 121 and service provider computing device 114. In the example embodiment, host computing device 112 is configured to store, at block 434, the received personal record in memory 120, and inform cardholder 22 of the successful storage at Block 436.

In at least some embodiments, host computing device 112 may be configured to prompt, at Block 424, cardholder 22 with an associated personal record transaction request after the personal record storage transaction. Block 424 and accompanying Block 450 are described above.

In the example embodiment, when the personal record transaction is determined to be a personal record transfer transaction, host computing device 112 may be configured to provide, at Block 440, a list of personal records stored in memory 120 that are available to be transferred to cardholder computing device 121. Host computing device 112 may further be configured to receive, at Block 442, an indication of the personal record cardholder 22 has selected to transfer.

In the example embodiment, host computing device 112 may retrieve, at Block 444, the personal record to be transferred from memory 120, and transmit the retrieved personal record to at least one of cardholder computing device 121 and service provider computing device 114 at Block 446. In the example embodiment, host computing device 112 may be configured to receive a service provider ID associated with service provider computing device 114. Further in the example embodiment, host computing device 112 is configured to verify the service provider ID before transmitting a personal record to service provider computing device 114. In the example embodiment, host computing device 112 is configured to inform cardholder 22 of the successful transfer at Block 448.

In at least some embodiments, host computing device 112 may be configured to prompt, at Block 424, cardholder 22 with an associated personal record transaction request after the personal record transfer transaction. Block 424 and accompanying Block 450 are described above.

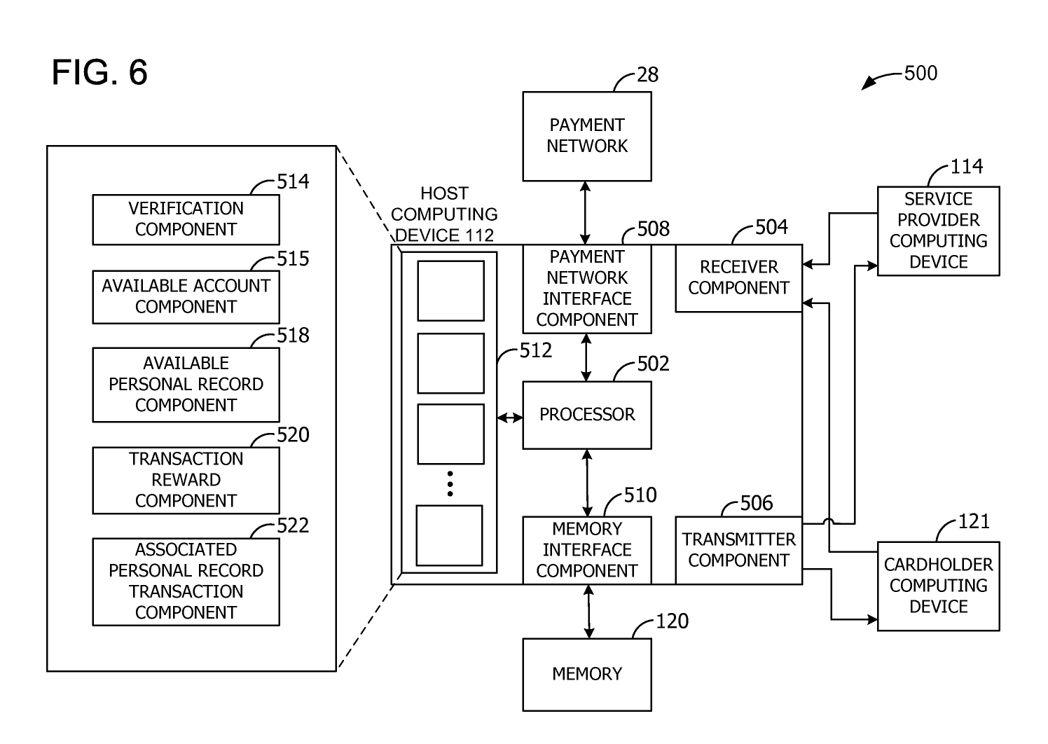

FIG. 6 illustrates a component view 500 of the payment and record system 100 as illustrated in FIG. 2.

Host computing device 112 comprises multiple components for performing the functions described herein. More specifically, host computing device 112 comprises a processor 502, receiver component 504, transmitter component 506, payment network interface component 508, memory interface component 510, verification component 514, available account component 516, available personal record component 518, transaction reward component 520, and an associated personal record transaction component 522.

Processor 502 may be any device capable of executing computer-executable instructions. Processor 502 may be configured to process and direct data from one component to another component. In the example embodiment, processor 502 may be the Central Processing Unit (CPU) of host computing device 112.

Receiver component 504 may be any device capable of receiving a signal. In the example embodiment, receiver component 504 includes a network adapter for receiving data through a network connection such as a WAN or LAN. Receiver component 504 is communicatively coupled to at least one of service provider computing device 114, cardholder computing device 121, and processor 502. Receiver component 504 is configured to receive data from at least one of cardholder computing device 121 and service provider computing device 114 and route the data to processor 502.

Transmitter component 506 may be any device capable of transmitting a signal. In the example embodiment, transmitter component 506 is a network adapter capable of transmitting data through a network connection such as a WAN or LAN. Transmitter component 506 is communicatively coupled to processor 502, service provider computing device 114, and cardholder computing device 121, and is configured to transmit signals from processor 502 to at least one of service provider device 114 and cardholder computing device 121.

Payment network interface component 508 may be any device or set of computer-executable instructions that enables host computing device 112 to communicate with payment network 28. In the example embodiment, payment network interface component 508 is a network adapter and sends and receives data through a network connection such as a WAN or LAN.

Memory interface component 510 may be any device or set of computer-executable instructions for communicating with memory 120. In the example embodiment, memory interface 510 communicates with memory 120 to store and retrieve data.

Verification component 514 may be a device or set of computer-executable instructions for verifying the identity of at least one of cardholder 22 and the service provider.

Available account component 516 may be a device or set of computer-executable instructions for determining payment accounts associated with cardholder 22 that are available for making a payment transaction. The available account component 516 may also provide a list of available accounts to cardholder computing device 121.

Available personal record component 518 may be any device or set of computer-executable instructions for determining personal records that are available to be stored or are available to be transferred. The personal records available to be transferred may be stored in memory 120. The personal records to be stored may be located on service provider computing device 114 or cardholder computing device 121.

Transaction reward component 520 may be a device or set of computer-executable instructions for determining whether any discounts, coupons, rewards points, product reviews, or other incentives, are associated with a particular payment transaction.

Associated personal record transaction component 522 may be any device or set of computer-executable instructions for determining whether an additional personal record transaction associated with at least one of a completed payment transaction and a completed personal record transaction is available.

While the embodiments have been described in terms of various specific embodiments, those skilled in the art will recognize that the embodiments can be practiced with modification within the spirit and scope of the claims. Specifically, though the embodiments described herein make reference to a host computing device 112 in communication with a plurality of computing devices and configured to perform certain functions; the disclosure contemplates that other devices or systems, such as service provider computing device 114 and cardholder computing device 121 may perform some or all of the functions ascribed to host computing device 112.

Further, the system may be implemented via a combination of hardware and software, as described, or entirely in hardware elements. Also, the particular division of functionality between the various system components described herein is merely for the purposes of example only, and not mandatory; functions performed by a single system component may instead be performed by multiple components, and functions performed by multiple components may instead performed by a single component.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

In one embodiment, a computer program is provided, and the program is embodied on a computer readable medium. In an example embodiment, the system is executed on a single computer system, without requiring a connection to a sever computer. In a further example embodiment, the system is being run in a Windows® environment. In yet another embodiment, the system is run on a mainframe environment and a UNIX® server environment. The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals, i.e., the “machine-readable medium” and the “computer-readable medium” are non-transitory. The term “machine-readable signal” refers to any signal used to provide machine instructions and/or data to a programmable processor.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A computer-implemented method for processing a payment transaction and a personal record associated with the payment transaction, the payment transaction initiated by a cardholder, said method implemented by a host computing device communicatively coupled to a memory, said method comprising:
receiving, at the host computing device, a request to authorize the payment transaction, wherein the authorization request includes a cardholder ID and a payment transaction amount;
transmitting an authorization confirmation message to at least one of a cardholder computing device and a first service provider computing device, the first service provider computing device being associated with a first service provider, the first service provider being associated with the payment transaction;
receiving a request to process a personal record transaction associated with the payment transaction and a second service provider, the second service provider having a second service provider computing device; and
processing, by the host computing device, the personal record transaction including at least one of (i) storing the personal record in the memory, and (ii) transmitting the personal record from the host computing device to at least one of the cardholder computing device and the second service provider computing device,
wherein the second service provider is the same as the first service provider or different than the first service provider.

2. The method of claim 1, wherein processing the personal record transaction includes:
receiving the personal record from one of the cardholder computing device and the second service provider computing device;
associating the personal record with the cardholder ID; and
storing the personal record in the memory.

3. The method of claim 1, wherein processing the personal record transaction includes:
retrieving the personal record from the memory based at least in part on the cardholder ID; and
transmitting the personal record from the host computing device to at least one of the cardholder computing device and the second service provider computing device.

4. The method of claim 1, wherein said method further includes
verifying the identity of the cardholder and the first service provider before transmitting an authorization confirmation message; and
verifying the identity of the second service provider before processing the personal record transaction.

5. The method of claim 1, wherein said method further includes transmitting a transaction reward message associated with the payment transaction to the cardholder computing device after processing the request to authorize the payment transaction, wherein the transaction reward message includes information regarding at least one of a coupon, discount, rebate, rewards point offer, or product review.

6. The method of claim 1, wherein said method further includes causing to be displayed on the cardholder computing device, at least one of a list of personal records stored within the memory and available to be transmitted to the second service provider, a list of personal records generated based on the payment transaction and available to be stored in the memory, and a list of payment accounts associated with the cardholder and available to send payments to the first service provider.

7. The method of claim 1, wherein said method further includes prompting the cardholder to instruct the host computing device to store the personal record in the memory.

8. The method of claim 1, wherein said method further includes prompting the cardholder to instruct the host computing device to transmit the personal record from the host computing device to at least one of the cardholder computing device and the second service provider computing device.

9. A method in accordance with claim 8, wherein transmitting the personal record includes at least one of transmitting an identifying document, financial history, insurance history, medical history, educational history, and legal history of the cardholder.

10. The method of claim 1, wherein receiving the request to process a personal record transaction occurs before receiving the request to authorize a payment transaction.

11. A payment and record management computer system for processing a payment transaction and a personal record associated with the payment transaction, the payment transaction initiated by a cardholder, said computer system comprising:
a memory; and
a host computing device communicatively coupled to the memory, the host computing device configured to:
receive a request to authorize the payment transaction, wherein the authorization request includes a cardholder ID and a payment transaction amount;
transmit an authorization confirmation message to at least one of a cardholder computing device and a first service provider computing device, the first service provider computing device being associated with a first service provider, the first service provider being associated with the payment transaction;
receive a request to process a personal record transaction associated with the payment transaction and a second service provider, the second service provider having a second service provider computing device; and
process the personal record transaction including at least one of (i) storing the personal record in the memory, and (ii) transmitting the personal record to at least one of the cardholder computing device and the second service provider computing device,
wherein the second service provider is the same as the first service provider or different than the first service provider.

12. The system of claim 11, wherein the host computing device is further configured to:
receive the personal record from one of the cardholder computing device and the second service provider computing device;
associate the personal record with the cardholder ID; and
store the personal record in the memory.

13. The system of claim 11, wherein the host computing device is further configured to:
retrieve the personal record from the memory based at least in part on the cardholder ID; and
transmit the personal record to at least one of the cardholder computing device and the second service provider computing device.

14. The system of claim 11, wherein the host computing device is further configured to:
verify the identity of the cardholder and the first service provider before transmitting an authorization confirmation message; and
verify the identity of the second service provider before processing the personal record transaction.

15. The system of claim 11, wherein the host computing device is further configured to transmit a transaction reward message associated with the payment transaction to the cardholder computing device after processing the request to authorize the payment transaction, wherein the transaction reward message includes information regarding at least one of a coupon, discount, rebate, rewards point offer, or product review.

16. The system of claim 11, wherein the host computing device is further configured to cause to be displayed on the cardholder computing device, at least one of a list of personal records stored within the memory and available to be transmitted to the second service provider, a list of personal records generated based on the payment transaction and available to be stored in the memory, and a list of payment accounts associated with the cardholder and available to send payments to the first service provider.

17. The system of claim 11, wherein the host computing device is further configured to prompt the cardholder to instruct the host computing device to store the personal record in the memory.

18. The system of claim 11, wherein the host computing device is further configured to prompt the cardholder to instruct the host computing device to transmit the personal record from the host computing device to at least one of the cardholder computing device and the second service provider computing device.

19. The system of claim 18, wherein the personal record includes at least one of an identifying document, financial history, insurance history, medical history, educational history, and legal history of the cardholder.

20. A computer readable medium having computer-executable instructions embodied thereon, wherein, when executed by a host computing device having at least one processor, the computer-executable instructions cause the at least one processor to:
receive a request to authorize a payment transaction initiated by a cardholder, wherein the authorization request includes a cardholder ID and a payment transaction amount;
transmit an authorization confirmation message to at least one of a cardholder computing device and a first service provider computing device, the first service provider computing device being associated with a first service provider, the first service provider being associated with the payment transaction;
receive a request to process a personal record transaction associated with the payment transaction and a second service provider, the second service provider having a second service provider computing device; and
process the personal record transaction including at least one of (i) storing the personal record in a memory, and (ii) transmitting the personal record to at least one of the cardholder computing device and the second service provider computing device,
wherein the second service provider is the same as the first service provider or different than the first service provider.

21. The computer readable medium of claim 20, wherein the computer-executable instructions further cause the at least one processor to:
receive the personal record from at least one of the cardholder computing device and the second service provider computing device;
associate the personal record with the cardholder ID; and
store the personal record in the memory.

22. The computer readable medium of claim 20, wherein the computer-executable instructions further cause the at least one processor to:
retrieve the personal record from the memory based at least in part on the cardholder ID; and
transmit the personal record to at least one of the cardholder computing device and the second service provider computing device.

23. The computer readable medium of claim 20, wherein the computer-executable instructions further cause the at least one processor to
verify the identity of the cardholder and the first service provider before transmitting an authorization confirmation message; and
verify the identity of the second service provider before processing the personal record transaction.

24. The computer readable medium of claim 20, wherein the computer-executable instructions further cause the at least one processor to prompt the cardholder to instruct the at least one processor to store the personal record in the memory.

25. The computer readable medium of claim 20, wherein the computer-executable instructions further cause the at least one processor to prompt the cardholder to instruct the at least one processor to transmit the personal record from the memory to at least one of the cardholder computing device and the second service provider computing device.

26. The computer readable medium of claim 25, wherein the personal record includes at least one of an identifying document, financial history, insurance history, medical history, educational history, and legal history of the cardholder.
